(19) United States
(12) Patent Application Publication
(10) Pub. No.: US 2024/0149734 A1
(43) Pub. Date: May 9, 2024

(54) METHOD OF PERFORMING A CHARGING OPERATION OF AN ELECTRICAL ENERGY STORAGE SYSTEM

(71) Applicant: Robert Bosch GmbH, Stuttgart (DE)

(72) Inventor: Stephan Eisenlauer, Oberriexingen (DE)

(21) Appl. No.: 18/503,707

(22) Filed: Nov. 7, 2023

(30) Foreign Application Priority Data
Nov. 9, 2022 (DE) 10 2022 211 840.5

(51) Int. Cl. B60L 53/62; B60L 53/66; B60L 58/13; H02J 7/00

(52) U.S. Cl. CPC B60L 53/62; B60L 53/66; B60L 58/13; H02J 7/007; B60L 58/27

(57) ABSTRACT

A method of performing a charging operation of an electrical energy storage system comprising charging electronics, comprising the steps:
a) determining at least one charging parameter relating to the electrical energy storage system;
b) transmitting the at least one charging parameter to the charging electronics of the electrical energy storage system;
c) starting the charging operation as a function of the at least one charging parameter.

A corresponding computer program, a machine-readable storage medium, an electronic control unit, and an electrical energy storage system are also described.

### BACKGROUND OF THE INVENTION

The present invention relates to a method of performing a charging operation of an electrical energy storage system comprising charging electronics.

Electric vehicles have a battery on board that does not or can not have its full capacity when it is cold. Therefore, it should be warmed up first before driving off. Many manufacturers have installed a heater for the battery, which often can even be turned on via APP, and heat the battery in this way before departure, i.e., can raise it to a temperature such that it can output more power.

However, this discharges the battery without moving the vehicle. Thus, many drivers, when possible, plug the vehicle into an electrical outlet overnight in order to prevent a heating of the battery the next morning at the expense of the battery charge.

What is important here is that the battery often should not be charged all night in these adverse conditions, because otherwise it is fully charged and then cools off, which significantly reduces the life of the battery. However, in the morning, after heating, it could charge for, e.g., one hour in order to recharge any losses from the heating (if power from the outlet has not been sufficient).

A method of charging an electric vehicle is disclosed in publication CN 108773278.

### SUMMARY OF THE INVENTION

A method of performing a charging operation of an electrical energy storage system comprising charging electronics is disclosed, having the features of the independent claim.

At least one charging parameter relating to the electrical energy storage system is determined. The at least one charging parameter is transmitted to the charging electronics of the electrical energy storage system. The charging operation is then started as a function of the at least one charging parameter.

The method is advantageous, because the charging operation can thus be performed as a function of at least one parameter, for example a user setting.

Further advantageous embodiments of the present invention are the subject-matter of the dependent claims.

Expediently, the at least one charging parameter includes at least one heating process parameter of the electrical energy storage system and/or a charging period of the electrical energy storage system. This is advantageous, because a heating operation can thus be influenced independently of a charging operation. A possible user can thus independently influence both properties and thus set up a charging operation which they deem optimal.

Expediently, the heating process parameter includes a heating period of the electrical energy storage system and/or a charging period of the electrical energy storage system. This is advantageous in order to be able to precisely define and influence the charging operation and, for example, to also specify different periods for heating and charging.

Expediently, the charging parameter includes a target state of charge of the electrical energy storage system and/or a target temperature of the electrical energy storage system. Thus, it can be precisely determined how the charging operation is to proceed and whether a sufficient state of charge is achieved.

Expediently, the at least one charging parameter includes a minimum state of charge, which may not be undershot during the charging operation of the electrical energy storage system. This is advantageous, because it is thus ensured that sufficient energy is always available in the electrical energy storage system for a specific purpose, for example, in a vehicle, a sufficiently high remaining range is always available, even when, for example, the heater of the vehicle or the electrical energy storage system is used.

Expediently, the determination of the at least one charging parameter includes a determination of a starting location, in particular when the electrical energy storage system is installed in a vehicle, and a determination of a target location to which the vehicle is to be driven. The charging parameter is then determined as a function of the starting location as well as the target location. This is advantageous, because an optimal charging operation can thus always be started.

The subject-matter of the invention is further a computer program comprising instructions which, when executed by a computer, cause the latter to perform the method according to the invention. The aforementioned advantages can be achieved as a result.

A further subject-matter of the invention is a machine-readable storage medium on which the computer program is stored. The aforementioned advantages can be achieved as a result.

The subject-matter of the invention is further an electronic control unit configured so as to perform all of the steps of the method according to the invention. The aforementioned advantages can be achieved as a result. The term electronic control unit can be understood in particular to mean an electronic control unit comprising, for example, a microcontroller and/or an application-specific hardware module, e.g., an ASIC, but it can also mean a computer or a programmable logic controller.

Furthermore, the subject-matter of the invention is an electrical energy storage system comprising at least one electrical energy storage unit, charging electronics, and an electronic control unit according to the invention. The aforementioned advantages can thus be achieved.

In particular, an electrical energy storage unit can be understood to mean an electrochemical battery cell and/or a battery module having at least one electrochemical battery cell and/or a battery pack having at least one battery module. For example, the electrical energy storage unit can be a lithium-based battery cell or a lithium-based battery module or a lithium-based battery pack. In particular, the electrical energy storage unit can be a lithium ion battery cell or a lithium ion battery module or a lithium ion battery pack. Furthermore, the battery cell can be of the type lithium polymer battery, nickel-metal hydride battery, lead-acid battery, lithium-air battery, or lithium-sulfur battery, or very generally a battery of any electrochemical composition.

### BRIEF DESCRIPTION OF THE DRAWINGS

Advantageous embodiments of the invention are illustrated in the drawings and explained in more detail in the description below.

Shown are:

FIG. 1 a flow chart of a first embodiment of the method according to the invention;

FIG. 2 a flow chart of a second embodiment of the method according to the invention; and

FIG. 3 a schematic illustration of an electrochemical energy storage system according to the invention according to one embodiment.

### DETAILED DESCRIPTION

In all of the figures, identical reference numerals denote identical device components or identical method steps.

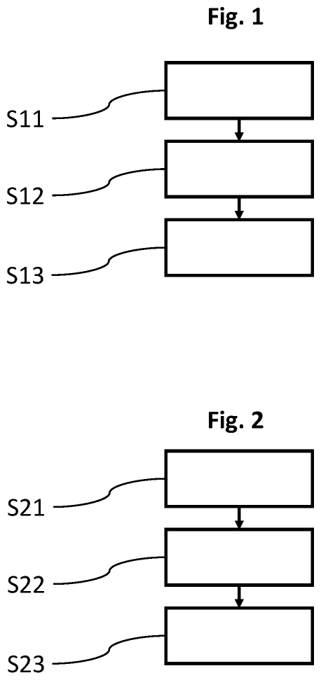

FIG. 1 shows a flow chart of a method according to the present invention of performing a charging operation of an electrical energy storage system comprising charging electronics according to a first embodiment.

In a first step S11, at least one charging parameter relating to the electrical energy storage system is determined. This can include, for example, querying a charging period and a heating period of the electrical energy storage system. Both can be determined, in particular, by a user via an interface, for example a so-called app. Here, for example, the user can set the time period for which they wish to switch on the heater of the electrical energy storage system and the time period for which they wish to perform the charging operation. Furthermore, further parameters or settings relating to the charging operation can be queried, for example a minimum state of charge that the electrical energy storage system may not fall below.

In a second step S12, the at least one charging parameter is transmitted to the charging electronics of the electrical energy storage system. The charging electronics are thus controlled according to the determined at least one charging parameter, for example relating to starting and ending the charging operation and the heating process, respectively.

In a third step S13, the charging operation is finally started as a function of the at least one charging parameter, in particular by the charging electronics.

FIG. 2 shows a flow chart of a method according to the present invention according to a second embodiment of performing a charging operation of an electrical energy storage system comprising charging electronics.

A drive to work in a vehicle with the electrical energy storage system, which can be configured in particular as a battery system, is to start at 6:30 a.m. Due to the outside temperature, a heating of the electrical energy storage system takes approximately 30 minutes, and the power required for this is 5 kW, for example. A maximum of 3 kW can be withdrawn from a Schuko socket, i.e., 2 kW must be withdrawn from the electrical energy storage system. 2 kW*30 min=1 kWh of energy is thus withdrawn from the electrical energy storage system, although the electrical energy storage system was plugged into the socket. Recharging for another 20 min is necessary in order to compensate for this loss. This requires the following procedure, for example:
5:40 a.m.: Turning on the heater and charging operation
6:10 a.m.: Turning off the heater, charging operation remains active
6:30 p.m.: Turning off the charging operation

If the second instruction is forgotten, the electrical energy storage system is still at operating temperature at 6:30 a.m., but has been discharged by nearly 2 kWh.

In the first step S21, the respective switch-on and switch-off times of the heating and charging can be determined, for example via an interface by a vehicle user. Then, in a second step S22, the corresponding parameters are transmitted to the charging electronics of the electrical energy storage system, and in a third step S23, the charging operation is started as a function of the corresponding parameters. Thus, at 6:30 a.m., a vehicle user can begin their journey with the vehicle fully warmed and charged.

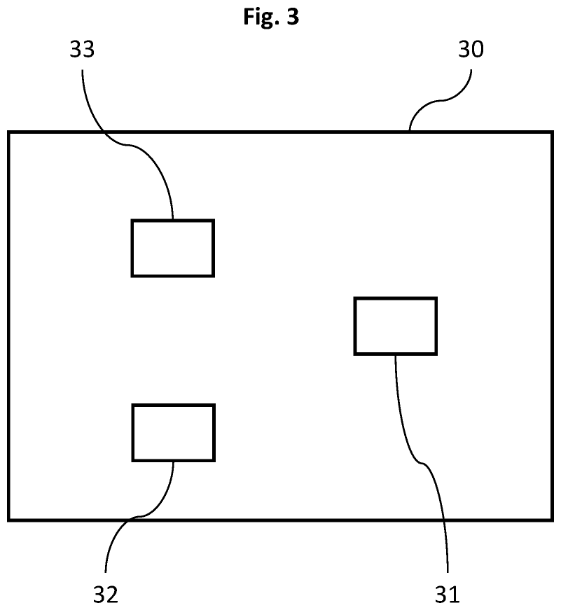

FIG. 3 shows a schematic illustration of an electrochemical energy storage system 30 according to the invention according to one embodiment. The electrical energy storage system 30 comprises at least one electrical energy storage unit 31, charging electronics 32, and an electronic control unit 33. The electronic control unit 33, which is shown separately here, can also be integrated into the charging electronics 32. The aforementioned components 31, 32, 33 are connected to one another via corresponding lines, which are not shown here, so that they can perform their respective function.

1. A method of performing a charging operation of an electrical energy storage system (30) comprising charging electronics (32), comprising the steps of
a) determining at least one charging parameter relating to the electrical energy storage system (30);
b) communicating the at least one charging parameter to the charging electronics (32) of the electrical energy storage system (30);
c) starting the charging operation as a function of the at least one charging parameter.

2. The method according to claim 1, wherein the at least one charging parameter includes at least one heating process parameter of the electrical energy storage system (30) and/or at least one charging operation parameter of the electrical energy storage system (30).

3. The method according to claim 2, wherein the heating operation parameter includes a heating period of the electrical energy storage system (30) and/or a charging period of the electrical energy storage system (30).

4. The method according to claim 1, wherein the charging parameter includes a target state of charge of the electrical energy storage system (30) and/or a target temperature of the electrical energy storage system (30).

5. The method according to claim 1, wherein the at least one charging parameter includes a minimum state of charge that may not be undershot during the charging operation of the electrical energy storage system (30).

6. The method according to claim 1, wherein step a) comprises
d) determining a starting location;
e) determining a target location;
wherein the charging parameter is determined as a function of the starting location and the target location.

7. A computer program comprising instructions which, when the program is executed by a computer, prompt said computer to perform the method according to claim 1.

8. A machine-readable storage medium on which the computer program according to claim 7 is stored.

9. An electronic control unit (33) configured to perform the steps of the method according to claim 1.

10. An electrical energy storage system (30) comprising at least one electrical energy storage unit (31), charging electronics (32), and an electronic control unit (33) according to claim 9.
